(19) United States
(12) Patent Application Publication
(10) Pub. No.: US 2011/0211192 A1
(43) Pub. Date: Sep. 1, 2011

(54) OPTICAL MEASURING DEVICE AND CALIBRATION DEVICE

(75) Inventors: Takeshi KIMURA, Ashigarakami-gun (JP); Hitoshi Shimizu, Ashigarakami-gun (JP)

(73) Assignee: FUJIFILM Corporation, Tokyo (JP)

(21) Appl. No.: 12/979,138

(22) Filed: Dec. 27, 2010

(30) Foreign Application Priority Data
Feb. 26, 2010 (JP) 2010-042215

(51) Int. Cl. G01J 1/10

(52) U.S. Cl. 356/243.1

(57) ABSTRACT

There is provided an optical measuring device including: plural light-receiving units; a frame to which the respective light-receiving units are mounted on a same circumference whose axial center is a predetermined position, with optical axes of the light-receiving units being directed toward the axial center, an object of measurement being disposed at an axially central portion of the circumference; a measuring section that outputs measured values corresponding to received light amounts; a reference sample disposed, instead of the object of measurement, at the axially central portion of the circumference such that a longitudinal direction of the reference sample runs along an axis of the circumference; a reference light source that illuminates light of the predetermined wavelength toward the reference sample; and a calibrating section that calibrates the sensitivities of the plural light-receiving units at a time of measuring the object of measurement.

### CROSS-REFERENCE TO RELATED APPLICATION

This application is based on and claims priority under 35 USC 119 from Japanese Patent Application No. 2010-042215 filed on Feb. 26, 2010, the disclosure of which is incorporated by reference herein.

### BACKGROUND

1. Technical Field

The present invention relates to an optical measuring device and a calibration device that are used in reconstructing a tomographic image, in which the object of measurement is a living body, by using optical tomography.

2. Related Art

Tissue of a living body is light-transmissive with respect to light of predetermined wavelengths, such as near infrared rays and the like. Thus, observation of the interior of a living body by using light can be carried out by receiving, at a light-receiving unit equipped with a light-receiving element and an optical system that introduces light of a predetermined wavelength to the light-receiving element and the like, light that has propagated through the interior of the living body and exited (optical tomography). For example, Japanese Patent Application Laid-Open (JP-A) No. 2008-032548 proposes a light scattering measurement device that carries out density measurement of a sample by using the transmission and scattering of light. In this light scattering measurement device, coherent light is illuminated onto particles within a liquid sample. Further, in the light scatter measuring device, plural photodetectors that are light-receiving units are disposed on a circumference that is centered around a sample cell that hold the liquid sample. The coherent light, that is transmitted through the sample cell, and the coherent light, that scatters within the liquid sample and is emitted at the periphery of the sample cell, are detected.

On the other hand, fluorescence tomography is proposed that, when observing a living body by using light, a fluorescent labeling agent, that provides a fluorescent substance or the like to antibodies that adhere uniquely to a specific region within the body of the living body, is administered to the object of measurement, and, by measuring the fluorescence that is emitted from the fluorescent labeling agent, the distributed state of the fluorescent labeling agent (the density of the fluorescence) within the living body, and the like are obtained.

In fluorescence tomography, excitation light is illuminated toward one point on the surface of a living body. The fluorescence, that is emitted from the fluorescent labeling material within the body due to the excitation light and that propagates while scattering within the body and exits to the exterior of the body, is measured at respective light-receiving units that are provided at plural places on a same flat surface (measurement surface). Due thereto, a tomographic image, that shows the density distribution of the fluorescence with the measurement surface being the cut surface, can be reconstructed. Further, by disposing numerous light-receiving units at the periphery of the living body that is the object of measurement, the measuring work at the time of measuring the fluorescence emitted from the living body can be reduced.

In a case of detecting intensity or the like of light by using plural light-receiving units, the measurement data that the light-receiving units output must be calibrated in order for the sensitivities to be considered to be equal.

Generally, in a case of carrying out calibration of sensitivity so that a light-receiving unit has the proper sensitivity, either a light source that is a reference is used, or a sample that is a reference is used, as proposed in JP-A Nos. 2008-032548, 60-154142, 63-25533, 02-141646, and the like. Further, as proposed in JP-A No. 2008-196890 and the like, when detecting fluorescence that is emitted due to excitation light being illuminated, a predetermined type of solution is used, and the intensity of the fluorescence that is emitted from the solution is used as an index.

On the other hand, there are cases in which there is dispersion among the sensitivities of the light-receiving elements. In a case of using plural light-receiving units at which light-receiving elements are respectively provided, the sensitivities of the light-receiving units must be made to be uniform. Here, JP-A No. 2009-101051 proposes using a holder that is structured by a substance whose light absorption coefficient is uniform, and that is provided with a light-sending spot at the center of a surface, and is provided with plural light-receiving spots in the same plane and on a same circumference whose axial center is the light-sending spot.

However, light amounts that are detected by light-receiving units vary also in accordance with the distance to the object of measurement. Therefore, in a case of carrying out calibration of sensitivities by removing the respective, plural light-receiving units from the optical measuring device, the work arises of having to mount, with high accuracy, the respective light-receiving units that have been removed.

### SUMMARY

The present invention was made in view of the above-described circumstances, and an object thereof is to provide an optical measuring device in which calibration of sensitivities of plural light-receiving units is easy, and a calibration device in which sensitivity calibration of plural light-receiving units provided at an optical measuring device is easy.

In order to achieve the above-described object, an optical measuring device of the present invention includes:

plural light-receiving units that each receive light of a predetermined wavelength via a light-receiving element;

a frame to which the respective light-receiving units are mounted on a same circumference whose axial center is a predetermined position, with optical axes of the light-receiving units being directed toward the axial center, an object of measurement being disposed at an axially central portion of the circumference;

a measuring section that, at the respective light-receiving elements of the plural light-receiving units, receives light exiting from the object of measurement that is disposed at the axially central portion of the circumference, and that outputs measured values corresponding to received light amounts;

a reference sample that is formed in a shape of a pillar having a predetermined cross-sectional shape and that is formed of a material at which isotropic scattering of light occurs as an optical characteristic, wherein in a case of carrying out calibration of sensitivities of the plurality of light-receiving units, the reference sample is disposed, instead of the object of measurement, at the axially central portion of the circumference such that a longitudinal direction of the reference sample runs along an axis of the circumference;

a reference light source that is disposed on the axis of the circumference so as to face one surface in the longitudinal direction of the reference sample that is disposed at the axially central portion of the circumference, and that illuminates light of the predetermined wavelength toward the reference sample; and

a calibrating section that calibrates the sensitivities of the plurality of light-receiving units at a time of measuring the object of measurement, on the basis of measured values for calibration that are outputted from the measuring section due to light, that exits from an outer peripheral surface of the reference sample in accordance with light illuminated from the reference light source onto the reference sample, being received at the respective light-receiving units.

Further, a calibration device of the present invention calibrates plural light-receiving units that are mounted to a frame on a same circumference whose axial center is a predetermined position, with optical axes of the light-receiving units being directed toward the axial center of the circumference, and that each receive light of a predetermined wavelength by a light-receiving element and output a measured value corresponding to a received light amount, the calibration device includes:

a reference sample that is formed in a shape of a pillar having a predetermined cross-sectional shape and of a material at which isotropic scattering of light occurs as an optical characteristic, and that is disposed at an axially central portion of the circumference such that a longitudinal direction of the reference sample runs along an axis of the circumference;

a reference light source that is disposed on the axis of the circumference so as to face one surface in the longitudinal direction of the reference sample, and that illuminates light of the predetermined wavelength toward the reference sample;

a measuring section that, at the respective light-receiving units, receives light exiting from an outer peripheral surface of the reference sample in accordance with light illuminated from the reference light source onto the reference sample, and that outputs measured values for calibration corresponding to received light amounts; and

a calibrating section that calibrates sensitivities of the plural light-receiving units on the basis of the measured values for calibration that are outputted from the measuring section.

In accordance with this invention, the plural light-receiving units are mounted to a frame so as to be on the same circumference. Light of a predetermined wavelength, that exits from an object of measurement or the like that is disposed at an axially central portion of the circumference, is measured in parallel by the plural light-receiving units. When carrying out calibration of the light-receiving units, a reference sample, that is formed in the shape of a pillar and of an anisotropic scattering medium, is disposed at the axially central portion, and light of a reference light source, that is provided so as to face one end surface of the reference sample, is illuminated.

Due thereto, the light amounts of the lights exiting from the outer peripheral surface of the reference sample toward the respective light-receiving units are equal. Therefore, sensitivity calibration of the plural light-receiving units can be carried out by using the measured values at this time as measured values for calibration.

At this time, in the present invention, because there is no need to remove the respective light-receiving units from the frame, the work for calibrating the sensitivities is very easy.

The optical measuring device of the present invention may further include a moving section that relatively moves the object of measurement and the frame, at which the light-receiving units are provided, along the axis of the circumference,

wherein the measuring section relatively moves the reference sample and the light-receiving units along the axial direction by the moving section, and outputs the measured values for calibration at a plurality of movement positions.

Further, the calibration device of the present invention may further include a moving section that relatively moves the reference sample and the frame, at which the light-receiving units are provided, along the axis of the circumference,

wherein the measuring section relatively moves the reference sample and the light-receiving units along the axis by the moving section, and outputs the measured values for calibration at plural movement positions.

In accordance with this invention, the reference sample and the light-receiving units move relatively. Due thereto, the distance over which the light, that is received at the light-receiving units, propagates within the reference sample can be changed. Therefore, because the amount of light that is received at the light-receiving units can be changed without changing the light amount of the light source, the dynamic range that is calibrated can be widened.

The optical measuring device of the present invention may further include a rotating section that relatively rotates the frame, at which the light-receiving units are provided, with respect to the object of measurement in a direction of the circumference,

wherein the measuring section relatively rotates the light-receiving units with respect to the reference sample in the circumferential direction by the rotating section, and outputs the measured values for calibration at plural rotational positions.

Further, the calibration device of the present invention may further include a rotating section that relatively rotates, in a direction of the circumference, the object of measurement with respect to the frame at which the light-receiving units are provided,

wherein the measuring section relatively rotates the light-receiving units with respect to the reference sample by the rotating section, and outputs the measured values for calibration at plural rotational positions.

In accordance with this invention, the light-receiving units and the reference sample rotate relatively, the light exiting from the reference sample is measured at the respective light-receiving units, and calibration is carried out by using the measured values obtained by this measurement. Due thereto, the occurrence of errors caused by the outer shape of the reference sample can be suppressed.

In the optical measuring device of the present invention, the calibrating section may include a calibration setting section that, from the measured values for calibration that the measuring section outputs, sets a calibration coefficient for each of the light-receiving units such that the measured values for calibration of the respective light-receiving units coincide.

Further, in the calibration device of the present invention, the calibrating section may include a calibration setting section that, from the measured values for calibration that the measuring section outputs, sets a calibration coefficient for each of the light-receiving units such that the measured values for calibration of the respective light-receiving units coincide.

In accordance with this invention, calibration coefficients for calibrating the respective measured values of the light-receiving units are set on the basis of the measured values obtained by using the reference light source and the reference sample. Due thereto, highly-accurate measured values are obtained when carrying out measurement with respect to an object of measurement.

The optical measuring device to which this invention is applied may further include a calibration processing section that, on the basis of the calibration coefficients set at the calibration setting section, carries out calibration of the measured values of the respective light-receiving units that are outputted from the measuring section.

Further, the optical measuring device may further include a light source that is provided at the frame and that illuminates, toward the axially central portion, excitation light with respect to a fluorescent labeling agent that is contained in the object of measurement, wherein the measuring section measures, at each of the plural light-receiving units, fluorescence that is emitted from the fluorescent labeling agent of the object of measurement in accordance with the excitation light illuminated from the light source.

As described above, in accordance with the present invention, sensitivity calibration can be carried out without removing the plural light-receiving units from the frame. Therefore, the sensitivity calibration work is easy, and there is no need to mount the light-receiving units again. Thus, there is the effect that the calibrated sensitivities are not disturbed.

Further, in the present invention, the light amount received at the light-receiving units can be changed without changing the light amount of the reference light source. Therefore, there is the effect that the dynamic range that is calibrated can be made to be wide.

Moreover, in the present invention, the occurrence of errors due to the outer shape of the reference sample can be suppressed.

### BRIEF DESCRIPTION OF THE DRAWINGS

An exemplary embodiment of the present invention will be described in detail based on the following figures, wherein:

FIG. 1 is a schematic perspective view showing relative positions of a reference member for calibration, a reference light source unit, and plural light-receiving units relating to the present invention;

FIG. 2 is a schematic structural drawing of main portions, showing a state in which the reference member for calibration is installed in an optical measuring device;

FIG. 3 is a schematic structural drawing of main portions of an optical tomographic measuring system relating to a present exemplary embodiment;

FIG. 4 is a perspective view showing the schematic structure of main portions of the optical measuring device;

FIG. 5 is a schematic structural drawing, as seen from one direction intersecting the axial direction of a frame, of main portions of the optical measuring device;

FIG. 6 is a schematic perspective view showing an example of a mouse, that is an object of measurement, and a subject holder;

FIG. 7 is a schematic structural drawing of main portions, showing a state in which the subject holder that accommodates the mouse is installed in the optical measuring device;

FIG. 8 is a block diagram showing a control section of the optical tomographic measuring system;

FIG. 9 is a functional block diagram of main portions of a data processing device; and

FIG. 10 is a graph showing an example of measurement data that has been standardized with respect to the movement position of a measurement surface.

### DETAILED DESCRIPTION

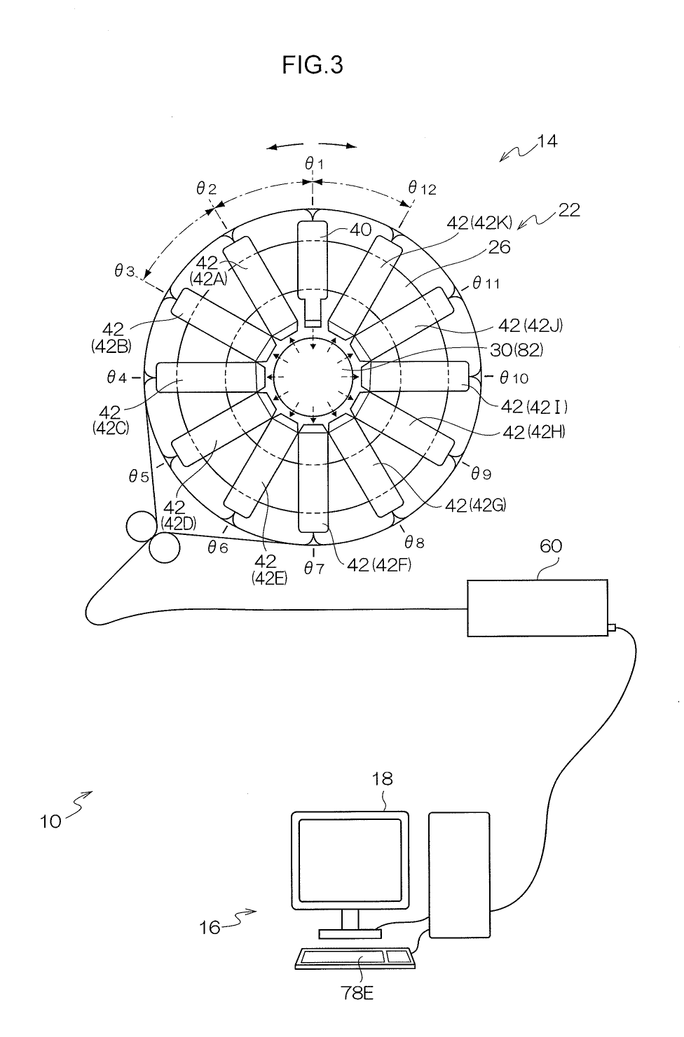

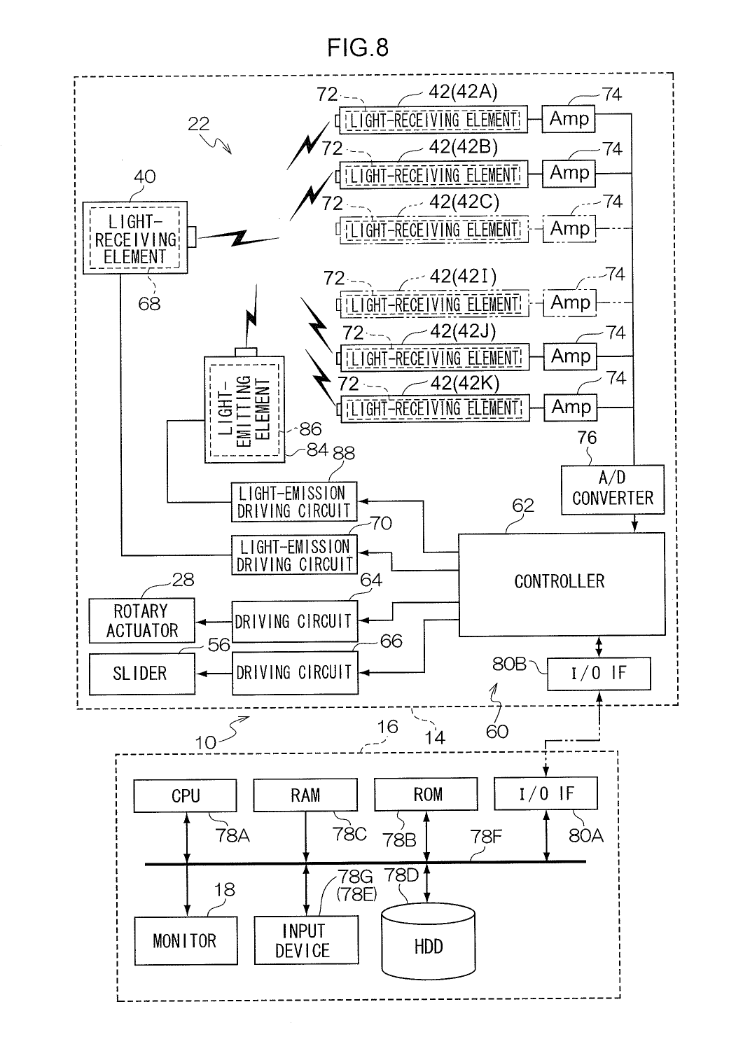

An exemplary embodiment of the present invention is described hereinafter with reference to the drawings. The schematic structure of an optical tomographic measuring system 10 relating to the present exemplary embodiment is shown in FIG. 3 and FIG. 8. The optical tomographic measuring system 10 has an optical measuring device 14 relating to the present invention, and a data processing device 16 that carries out predetermined data processing on measurement data obtained at the optical measuring device 14. Note that the optical tomographic measuring system 10 may be a structure in which the functions of the optical measuring device 14 and the functions of the data processing device 16 are integrated.

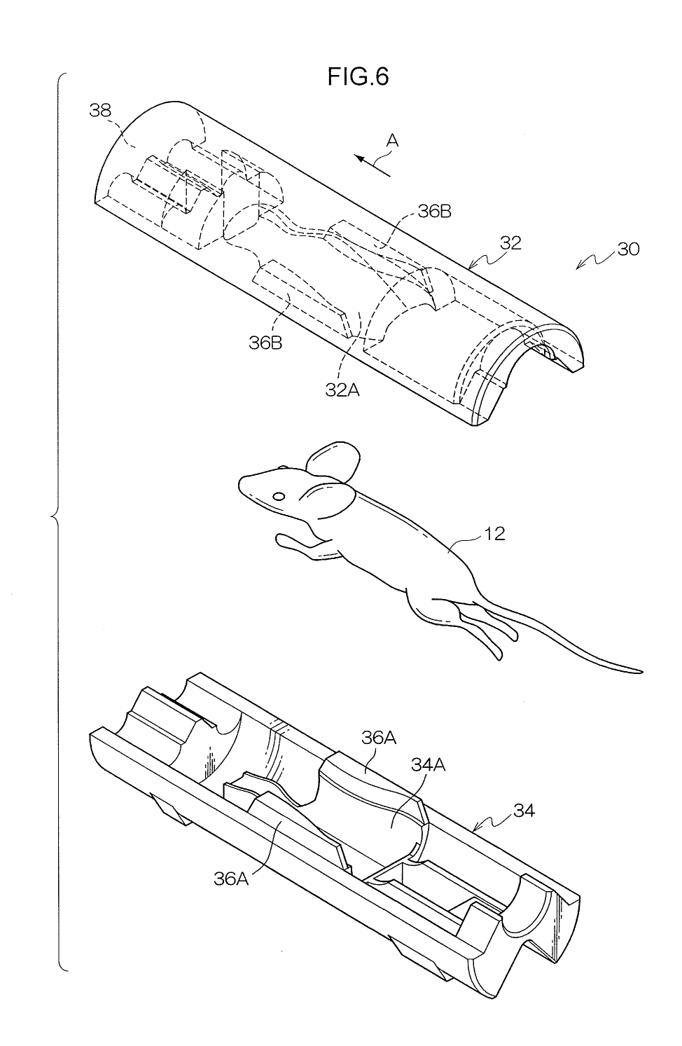

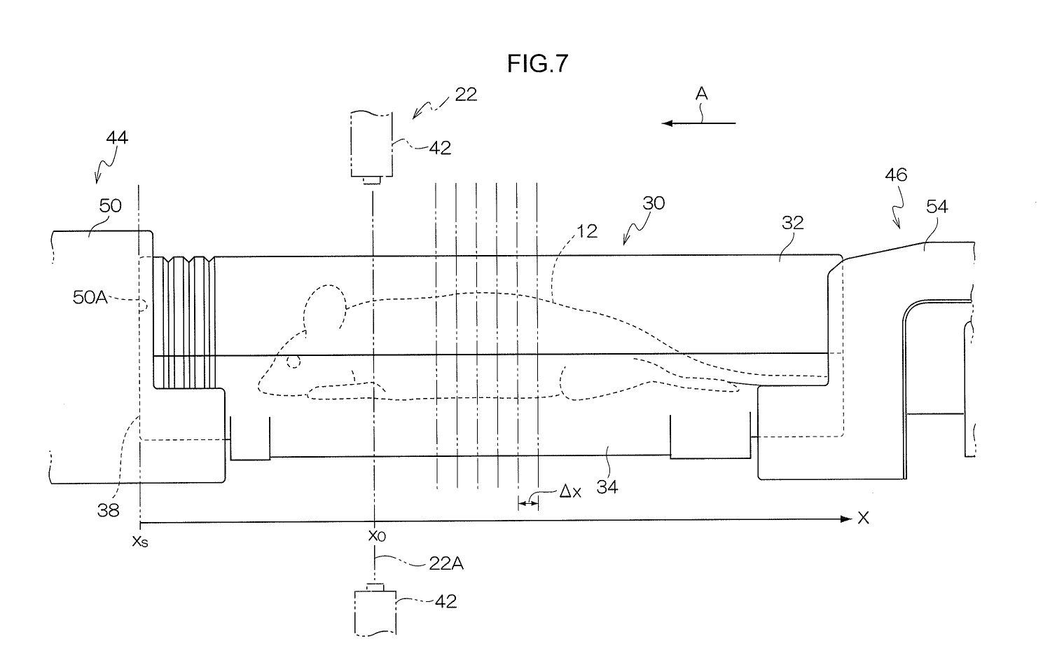

At the optical tomographic measuring system 10, a living body, such as a small animal or the like such as a nude mouse or the like for example, is the object of measurement. A fluorescent labeling agent is administered to this object of measurement, and a tomographic image, that shows the density distribution within the body of the administered fluorescent labeling agent (fluorescent substance), is generated (an optical tomographic image is reconstructed). The reconstructed optical tomographic image is, for example, displayed on a monitor 18 or the like. Note that, hereinafter, a mouse 12 (see FIG. 6, FIG. 7) is described as the object of measurement, but the optical measuring device 14 is not limited to the same, and an arbitrary living body can be used as the object of measurement.

Lesion cells, such as tumor cells or the like, or the like are injected or the like in advance into the mouse 12 that is the object of measurement, so as to give rise to (manifest) a lesion such as a tumor or the like. For example, an agent in which a fluorescent substance is contained in antibodies that adhere uniquely to a specific region such as the lesion or the like, is used as the fluorescent labeling agent that is administered to the mouse 12. When a fluorescent labeling agent is administered to the mouse 12 at which a lesion has been generated, the fluorescent labeling agent is dispersed within the body of the mouse 12 due to blood circulation, and thereafter, adheres to the lesion due to the antigen-antibody reaction.

In the optical tomographic measuring system 10, for example, at the time when the fluorescent labeling agent administered to the mouse 12 adheres to the lesion of the mouse 12, the mouse 12 is loaded into the optical measuring device 14. The optical measuring device 14 illuminates, onto the mouse 12, excitation light with respect to the fluorescent labeling agent, and the fluorescence intensity emitted from the fluorescent labeling agent within the body of the mouse 12 is measured. At the data processing device 16, the density distribution of the fluorescence (fluorescent labeling agent) within the mouse 12 is computed on the basis of the measurement data that corresponds to the fluorescence intensity outputted from the optical measuring device 14.

As shown in FIG. 6 and FIG. 7, in the optical measuring device 14 that is applied to the present exemplary embodiment, the mouse 12 is loaded and accommodated in a subject holder 30. As shown in FIG. 6, the subject holder 30 is structured by an upper mold block 32 and a lower mold block 34. The subject holder 30 becomes a substantially cylindrical shape of a predetermined outer diameter due to the upper mold block 32 and the lower mold block 34 being superposed one on the other.

A recess 32A, that conforms to the physique (the outer shape and size) of the dorsal side of the mouse 12, is formed in the upper mold block 32. A recess 34A, that conforms to the physique of the ventral side of the mouse 12, is formed in the lower mold block 34. Due to the upper mold block 32 being placed on the lower mold block 34 in the state in which the ventral side of the mouse 12 is accommodated within the recess 34A of the lower mold block 34, the mouse 12 is disposed such that the body length direction thereof runs along the axial direction of the subject holder 30, and is accommodated within the subject block 30 with the skin thereof closely contacting the inner surface of the subject holder 30. Note that, at the subject holder 30, positioning between the upper mold block 32 and the lower mold block 34 is carried out by, for example, a pair of engaging projections 36A at the lower mold block 34 being fit into engaging recesses 36B of the upper mold block 32.

Here, in the present exemplary embodiment, mainly the torso portion (from the chest region to the hip region) of the mouse 12 is the measurement region, and the subject holder 30 holds the mouse 12 in a state in which the skin of at least the torso portion of the mouse 12 closely contacts the inner surface of the subject holder 30. Further, at the subject holder 30, the end surface at the head portion side of the mouse 12 for example is a reference surface 38. When the mouse 12 is accommodated in the subject holder 30, the positions of the respective internal organs with respect to the reference surface 38 are determined in accordance with the physique (size).

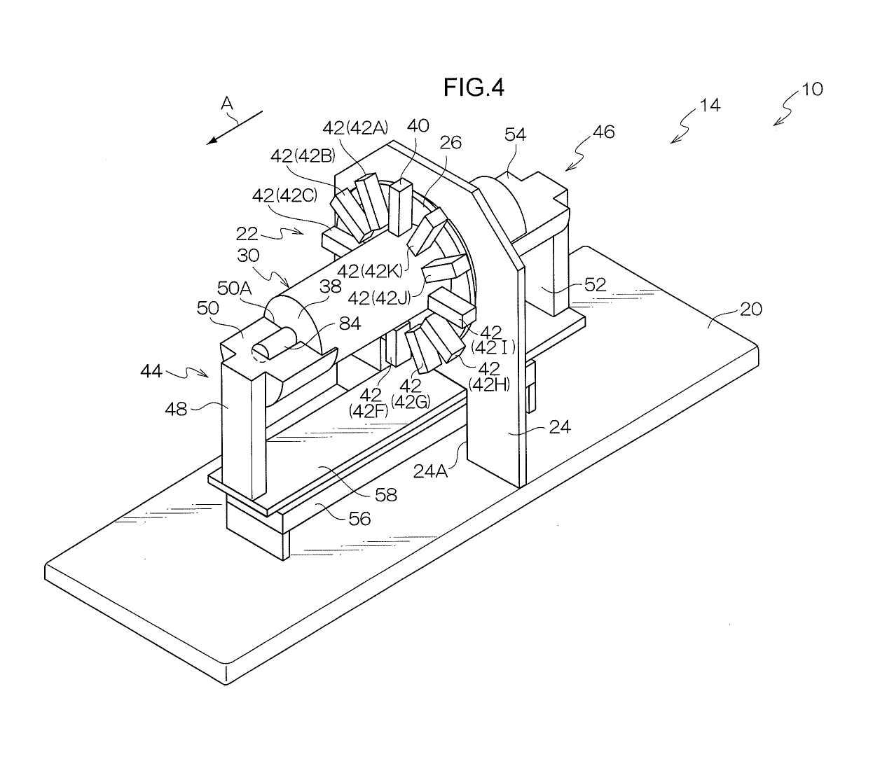

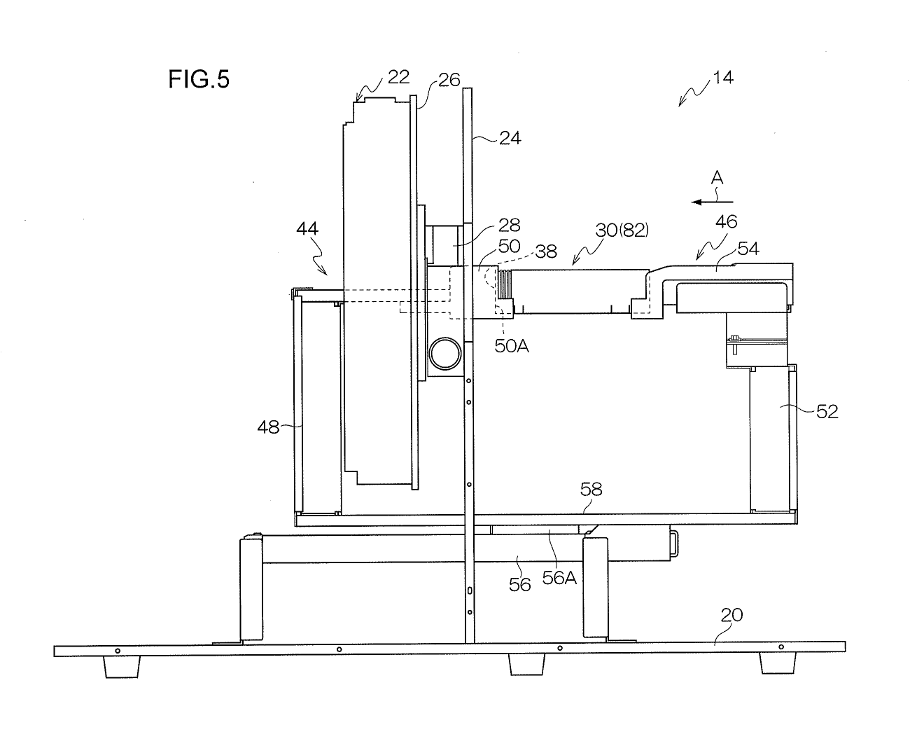

As shown in FIG. 4 and FIG. 5, a stand 20 is disposed at the interior of the optical measuring device 14, which interior is shielded from light by an unillustrated casing. A base plate 24 stands erect on this stand 20. A measuring head portion 22 is provided at one surface of the base plate 24. As shown from FIG. 3 through FIG. 5, the measuring head portion 22 has a frame 26 that is formed in the shape of a ring, and the frame 26 is disposed so as to be coaxial with an unillustrated circular hole that is formed in the base plate 24.

As shown in FIG. 5, a rotary actuator (rotating portion) 28 is mounted to one surface of the base plate 24. The frame 26 is mounted to the rotary actuator 28. An unillustrated cavity portion, that corresponds to the circular hole of the base plate 24, is formed in the rotary actuator 28, and this cavity portion is mounted to the base plate 24 so as to be coaxial with the circular hole. The frame 26 is mounted to the rotary actuator 28 so as to be coaxial with the cavity portion.

The rotary actuator 28 is driven and rotated by the driving force of an unillustrated motor such as, for example, a steeping motor, a pulse motor, or the like. Due thereto, at the optical measuring device 14, the frame 26 is rotated around its own axial center. Note that the rotary actuator 28 is not limited to a motor, and a drive source of an arbitrary structure, such as driven by air or the like, can be used.

As shown in FIG. 4 and FIG. 5, arms 44, 46 are provided at the optical measuring device 14 as a pair with the base plate 24 sandwiched therebetween. At the arm 46, a bracket 50 is mounted to the distal end portion of a support 48, and the distal end of the bracket 50 passes through the opening of the frame 26 and is directed toward the arm 46 side. Further, at the arm 46, a bracket 54 is mounted to the distal end portion of a support 52, and the distal end of the bracket 54 passes through the opening of the frame 26 and is directed toward the arm 44 side.

An elongated slider 56 and slide base 58 are disposed above the stand 20. The longitudinal direction of the slider 56 is disposed along the axial direction of the frame 26 (the left-right direction of the drawings of FIG. 4 and FIG. 5). The slider 56 is inserted through an opening portion 24A (see FIG. 4) that is formed in the lower end portion of the base plate 24, and is mounted onto the base 20. The longitudinal direction of the slide base 58 is disposed so as to run along the longitudinal direction of the slider 56, and the slide base 58 is mounted to a block 56A of the slider 56. Further, the support 48 of the arm 44 stands erect at one longitudinal direction end side of the slide base 58, and the support 52 of the arm 46 stands erect at the other end side.

A feed screw mechanism (not illustrated), whose driving source is a stepping motor or the like, is provided at the interior of the slider 56. Due to the stepping motor being driven, the block 56A moves along the longitudinal direction (the left-right direction of the drawing of FIG. 5). Due thereto, at the optical measuring device 14, the pair of arms 44, 46 are moved integrally in the axial direction of the frame 26. Note that, here, the arms 44, 46 move, but the present invention is not limited to the same and may be a structure in which the frame 26 (the measuring head portion 22) moves.

At the optical measuring device 14, the subject holder 30 is installed so as to span between the bracket 50 of the arm 44 and the bracket 54 of the arm 46. At this time, the subject holder 30 is disposed such that the axis thereof runs along the axial center of the frame 26 and overlaps the axial center. Further, the reference surface 38 of the subject holder 30 is positioned by being abutted against a reference surface 50A that is set at the bracket 50.

At the optical measuring device 14, the subject holder 30 is installed between the brackets 44, 46 in a state in which the bracket 50 of the arm 44 has been moved to a position at the side opposite the frame 26 with the base plate 24 therebetween. At the optical measuring device 14, by driving the slider 56, the subject holder 30 moves in the direction of arrow A so as to pass through the axially central portion of the frame 26. Further, at the optical measuring device 14, the subject holder 30 is removed from the arms 44, 46 by being moved in the direction opposite to the direction of arrow A and returned to the installation position.

On the other hand, as shown in FIG. 3 and FIG. 4, a light source unit 40 and plural light-receiving units 42 are provided at the measuring head portion 22. The light source unit 40 has a light-emitting element, such as an LED or a semiconductor laser or the like, that emits light of a predetermined wavelength that is the excitation light. Each of the plural light-receiving units 42 has a light-receiving element that receives fluorescence emitted from the mouse 12.

As shown in FIG. 3, the light source unit 40 and the light-receiving units 42 are disposed such that the respective optical axes thereof are directed toward the axial center of the frame 26, and are disposed on a plane (see FIG. 7, hereinafter called “measurement surface 22A”) that intersects the axial direction of the frame 26. Further, the light source unit 40 and the light-receiving units 42 are disposed in a radial form from the axial center of the frame 26, such that the angles between the optical axes thereof are a predetermined angle θ.

In the optical measuring device 14, the light source unit 40 and the plural light-receiving units 42 are mounted to the frame 26 so as to be on the same circumference whose axial center is a predetermined position. The frame 26 is not limited to a ring shape, and may be an arbitrary shape provided that at least the plural light-receiving units 42 are mounted so as to be on the same circumference and the optical axes of the respective light-receiving units 42 are directed toward the axial center of that circumference.

Further, in the present exemplary embodiment, as an example, the one light source unit 40 and eleven light-receiving units 42A, 42B, 42C, 42D, 42E, 42F, 42G, 42H, 42I, 42J, 42K are provided, and the one light source unit 40 and the eleven light-receiving units 42A through 42K are mounted to the frame 26 such that the angle θ is 30°. However, the number of and the placement interval (mounting angle) of the light-receiving units 42 are not limited to the same.

In the state in which the subject holder 30 that is installed at the arms 44, 46 is disposed at the axially central portion of the frame 26, the optical measuring device 14 illuminates excitation light, that is emitted from the light source unit 40, onto the peripheral surface of the subject holder 30. Further, at the optical measuring device 14, the light (fluorescence), that is emitted from the fluorescent labeling agent within the body of the mouse 12 due to the excitation light being illuminated and that exits from the outer peripheral surface of the subject holder 30, is detected at the respective light-receiving units 42.

At this time, at the optical measuring device 14, the measuring head portion 22 (the light source unit 40 and the light-receiving units 42) is rotated in the peripheral direction of the subject holder 30 due to the driving of the rotary actuator 28, and the illuminating position of the excitation light and the light-receiving positions of the fluorescence are changed, and measurement of the fluorescence is carried out at the respective positions. Further, in the optical measuring device 14, the subject holder 30 is moved along the axial direction of the frame 26 by the slider 56, and measurement of the fluorescence is carried out at predetermined positions or predetermined intervals along the axial direction of the subject holder 30.

Due thereto, the optical measuring device 14 measures the fluorescence, that is emitted from the fluorescent labeling agent within the body of the mouse 12, at arbitrary positions along the body length direction of the mouse 12, and measurement data that corresponds to the intensity of the measured fluorescence is obtained.

On the other hand, as shown in FIG. 8, a control section 60 is provided at the optical measuring device 14. A controller 62 equipped with an unillustrated microcomputer is provided at the control section 60.

A driving circuit 64, that drives the unillustrated motor of the rotary actuator 28, and a driving circuit 66, that drives the unillustrated motor of the slider 56, are provided at the control section 60. The driving circuit 64 and the driving circuit 66 are connected to the controller 62. The movement of the subject holder 30 and the rotation of the measuring head portion 22 are thereby controlled at the optical measuring device 14.

The light source unit 40 has a light-emitting element 68. The light-receiving unit 42 has a light-receiving element 72 and an unillustrated optical filter. At the light-receiving unit 42, light of the wavelength of fluorescence is guided to the light-receiving element 72 by the optical filter. The control section 60 has a light emission driving circuit 70 that drives the light-emitting element 68, amplifiers (amp) 74 that amplify electric signals outputted from the light-receiving elements 72, and an A/D converter 76 that carries out A/D conversion on the electric signals (analog signals) outputted from the amplifiers 74.

The control section 60 outputs the measurement data, that is detected by the light-receiving elements 72 of the respective light-receiving units 42, as digital signals while controlling the emission of light by the light-emitting element 68 of the light source unit 40. Note that the optical measuring device 14 may be provided with a display panel on which the operating state of the device and the like are displayed by the controller 62.

A computer of a general structure in which a CPU 78A, a ROM 78B, a RAM 78C, an HDD 78D that is a storage portion, an input device 78G such as a keyboard 78E (see FIG. 3) or a mouse or the like, the monitor 18, and the like are connected to a bus 78F, is formed at the data processing device 16.

An input/output interface (I/O IF) 80A is provided at the data processing device 16. The input/output interface 80A is connected to an input/output interface 80B that is provided at the control section 60 of the optical measuring device 14. Due thereto, the measurement data that has been measured at the optical measuring device 14 is inputted to the data processing device 16. Note that a known, arbitrary standard, such as a USB interface or the like, can be applied to the connection between the optical measuring device 14 and the data processing device 16.

The data processing device 16 controls the operations of the optical measuring device 14 due to the CPU 78A executing programs stored in the ROM 78B or the HDD 78D by using the RAM 78C as a work memory, and measures the intensity of the fluorescence emitted from the mouse 12. Further, the data processing device 16 reads-in the measurement data obtained by the measurement at the optical measuring device 14, and, on the basis of this measurement data, reconstructs a tomographic image that expresses the intensity distribution of the fluorescence. Note that, in the optical tomographic measuring system 10, the data processing device 16 is not limited to a structure that controls the operations of the optical measuring device 14, and the optical measuring device 14 may operated independently and may output the measurement data.

The living body such as the mouse 12 or the like is an anisotropic scattering medium with respect to light. At an anisotropic scattering medium, forward scattering is the dominant region until the incident light reaches the light penetration length (equivalent scattering length), and, in regions past the light penetration length, multiple scattering (isotropic scattering) in which the deflection of the light is random occurs, and the scattering of the light becomes isotropic (isotropic scattering region). The region in which the forward scattering is dominant is narrow at around several mm. Therefore, in a case in which anisotropic scattering media contact one another, one anisotropic scattering medium and the other anisotropic scattering media can be considered to be an integral anisotropic scattering medium.

In the present exemplary embodiment, the subject holder 30 is formed by using a material that is an anisotropic scattering medium, in order for the interior of the subject holder 30 (the upper mold block 32 and the lower mold block 34) that accommodates the mouse 12 to substantially be considered to be an isotropic scattering region. Polyethylene (PE), polyacetal resin (POM) whose equivalent scattering coefficient μ′ of light is 1.05 mm⁻¹, or the like can be used as the material of the subject holder 30. Note that the material that forms the subject holder 30 is not limited to the same, and an arbitrary material can be used provided that it is an anisotropic scattering medium.

If the interior of the subject holder 30 in which the mouse 12 is accommodated can substantially be considered to be an isotropic scattering region, the scattering of the light within the body of the mouse 12 can approximate isotropic scattering.

When light propagates within a highly-dense medium while being scattered, the distribution of the light intensity is expressed by a transport equation of light (photons) that is a basic equation expressing the flow of energy of photons. However, due to the scattering of the light approximating isotropic scattering, the distribution of the light intensity can be expressed by using a diffusion equation. At the data processing device 16, the density distribution of the light (fluorescence) is acquired by computing the solution of a diffusion equation by using the results of measurement (measurement data) of the optical measuring device 14. Further, the data processing device 16 displays, on the monitor 18 or the like, an optical tomographic image (a reconstructed optical tomographic image) of the mouse 12 that is based on the computed density distribution.

On the other hand, as shown in FIG. 3 and FIG. 7, at the optical measuring device 14, positioning of the mouse 12 that is accommodated within the subject holder 30 is carried out by the reference surface 38 of the subject holder 30 being made to abut the reference surface 50A that is set at the bracket 50 of the arm 44. Due thereto, for example, at the optical measuring device 14, the subject holder 30 is moved along the body length direction of the mouse 12 (the axial direction of the subject holder 30) from origin xs that is set on the basis of the reference surface 50A, as shown in FIG. 7. At this time, at the optical measuring device 14, the subject holder 30 is moved toward a position set in advance (measurement position x corresponding to a region, that is set in advance, of the mouse 12) relatively with respect to the origin xs, and measurement of fluorescence is carried out each predetermined interval Δx (e.g., Δx=3 mm) from this position.

Further, at the optical measuring device 14, the light source unit 40 rotates by the predetermined angle θ each time from an original position that is set in advance (e.g., from an original position θ₁ to rotational positions θ₂, θ₃, . . . θ₁₂). At each rotational position θ, measurement data D(m), that are output signals of the light-receiving units 42A through 42K, are read-in. Note that m is a variable that specifies the light-receiving unit 42A through 42K, and m=1 through 11.

Due thereto, in the optical measuring device 14, measurement data D(x,θ,m) is obtained. At this time, if the measurement position x is the same, the measurement data D(x,θ,m) are data on the same plane (the measurement surface 22A) that intersects the moving direction of the subject holder 30. Note that the measurement position x is also the position to which the measurement surface 22A has been moved, and therefore, is also called movement position x.

In a case in which the fluorescence emitted from the mouse 12 within the subject holder 30 is measured in parallel by using the plural light-receiving units 42 (42A through 42K), the sensitivities of the respective light-receiving units 42 must be made to be uniform. Namely, in a case in which fluorescence of the same intensity is measured, sensitivity calibration must be carried out in order for the measurement data outputted from the light-receiving units 42A through 42K to be uniform.

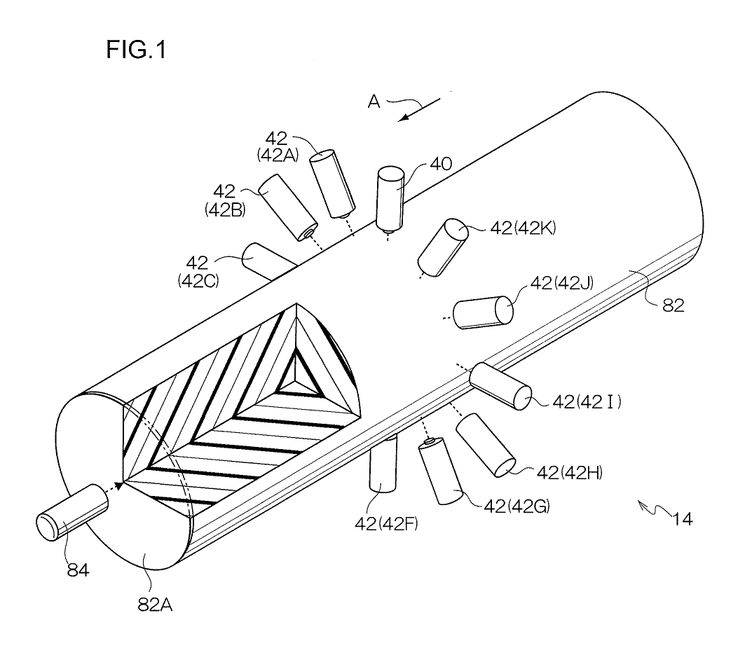

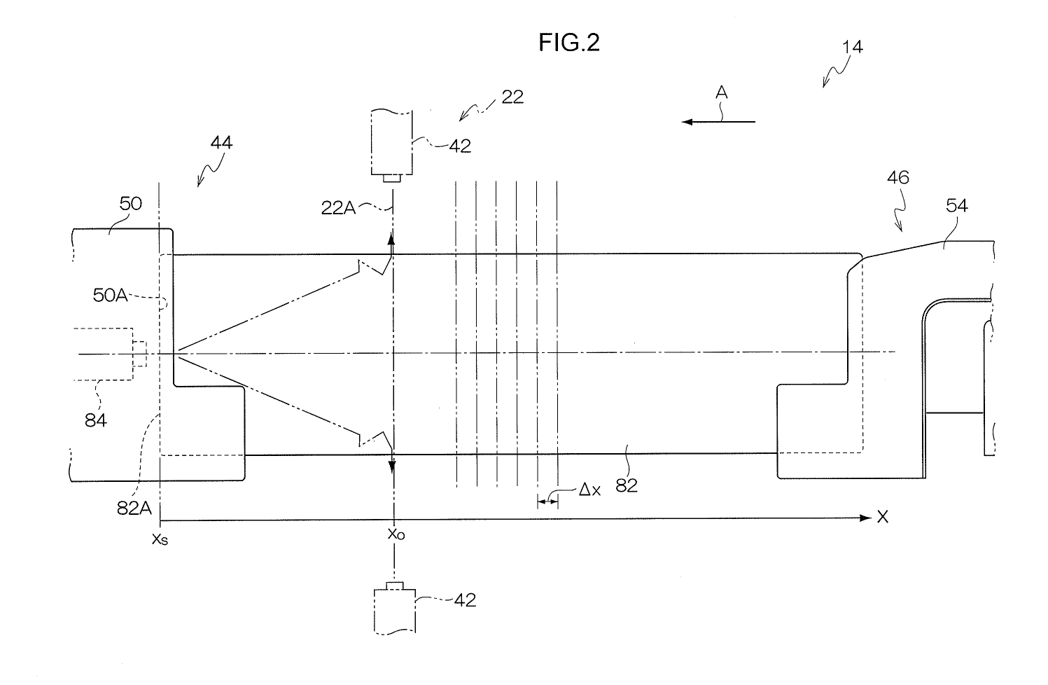

At the optical measuring device 14, when carrying out sensitivity calibration of the light-receiving units 42A through 42K, a reference member 82 for calibration that is a reference sample is used instead of the subject holder 30. As shown in FIG. 1 and FIG. 2, the reference member 82 for calibration is shaped as a solid cylinder of a predetermined diameter. The radius of the reference member 82 for calibration may be the same as that of the subject holder 30, or may be smaller than that of the subject holder 30. Or, the radius of the reference member 82 for calibration may be larger than that of the subject holder 30, provided that it is within a range such that the reference member 82 for calibration does not contact the light source unit 40 and the light-receiving units 42 when the reference member 82 for calibration is disposed at the axially central portion of the frame 26.

An anisotropic scattering medium such as POM or PE (polyethylene) or the like is used for the reference member 82 for calibration, and the reference member 82 for calibration is formed of the anisotropic scattering medium so as to be solid. At the optical measuring device 14, the reference member 82 for calibration is installed so as to span between the brackets 50, 54. One end surface of the reference member 82 for calibration is a reference surface 82A, and the reference member 82 for calibration is positioned by this reference surface 82A abutting the reference surface 50A of the bracket 50.

As shown in FIG. 2 and FIG. 4, a reference light source unit 84 is provided at the bracket 50 of the arm 44. The reference light source unit 84 is mounted so as to face the axially central portion of the reference surface 82A of the reference member 82 for calibration when the reference member 82 for calibration is installed at the brackets 50, 54.

As shown in FIG. 8, the reference light source unit 84 has a light-emitting element 86 that emits light of a predetermined wavelength. A light-emission driving circuit 88 is provided at the control section 60. The controller 62 controls the emission of light by the reference light source unit 84 by controlling the operation of the light-emission driving circuit 88.

At the optical measuring device 14, the wavelength of the light that the light-emitting element 86 emits is made to suit the wavelength of the fluorescence that is emitted by the fluorescent labeling agent administered to the mouse 12. For example, when the fluorescent labeling agent administered to the mouse 12 emits fluorescence of approximately 770 nm due to excitation light of a wavelength of approximately 730 nm being illuminated, at the optical measuring device 14, the optical characteristics (e.g., the band of the optical filters) of the light-receiving units 42 are set so as to receive light of that wavelength (approximately 770 nm). Thus, the light-emitting element 86, that emits light of a wavelength of approximately 770 nm that is suited to the optical characteristics of the light-receiving units 42, is used at the reference light source unit 84 that is provided at the optical measuring device 14.

As shown in FIG. 2, due to light being illuminated from the reference light source unit 84, the illuminated light propagates through the interior of the reference member 82 for calibration, and the propagated light exits from the peripheral surface and the other end surface. At the optical measuring device 14, the light that exits from the peripheral surface of the reference member 82 for calibration is received at the respective light-receiving units 42A through 42K, and data corresponding to the intensities (light amounts) of the received light is outputted as measurement data for calibration.

Here, due to the reference member 82 for calibration being formed by an anisotropic scattering medium, the light that is incident on the reference member 82 for calibration propagates while repeating isotropic scattering. Due thereto, at positions at which the distance from the reference surface 82A is the same (i.e., on the measurement surface 22A), the intensities of the lights that exit from the peripheral surface are the same. Thus, in the optical tomographic measuring system 10, calibration coefficients K(m) are set for the respective light-receiving units 42A through 42K, so that the measurement data obtained from the respective light-receiving units 42A through 42K of the optical measuring device 14 become equal values.

At the data processing device 16, the measurement data D(x,θ,m), that makes the sensitivities of the light-receiving units 42A through 42K equal, is obtained by using the calibration coefficients K(m). Note that the calibration coefficients K(m) are set to m=1 through 11, so as to correspond to the eleven light-receiving unit 42, respectively.

At the optical measuring device 14, by operating the rotary actuator 28, the rotational positions θ of the light-receiving units 42 along the peripheral direction of the reference member 82 for calibration can be changed. Due thereto, at the optical measuring device 14, when the light illuminated from the reference light source unit 84 is detected at the light-receiving units 42, the frame 26 is rotated by a predetermined angle (e.g., 30°) each time with respect to the same measurement surface 22A, and detection at the respective rotational positions θ can be carried out.

At the optical measuring device 14, by operating the slider 56, the measurement surface 22A of the measuring head portion 22 is moved relative to the reference member 82 for calibration in the axial direction of the reference member 82 for calibration, and measurement at the plural movement positions x can be carried out.

Due thereto, at the optical measuring device 14, measurement data Ds(x,θ,m) for calibration of each of the light-receiving units 42 is obtained at, for example, each rotational position θ and distance (movement position x) from the origin xs that is set at the reference surface 50A of the bracket 50 (or the reference surface 82A of the reference member 82 for calibration). In the optical tomographic measuring system 10, the measurement data Ds(x,θ,m) obtained at the optical measuring device 14 are outputted to the data processing device 16.

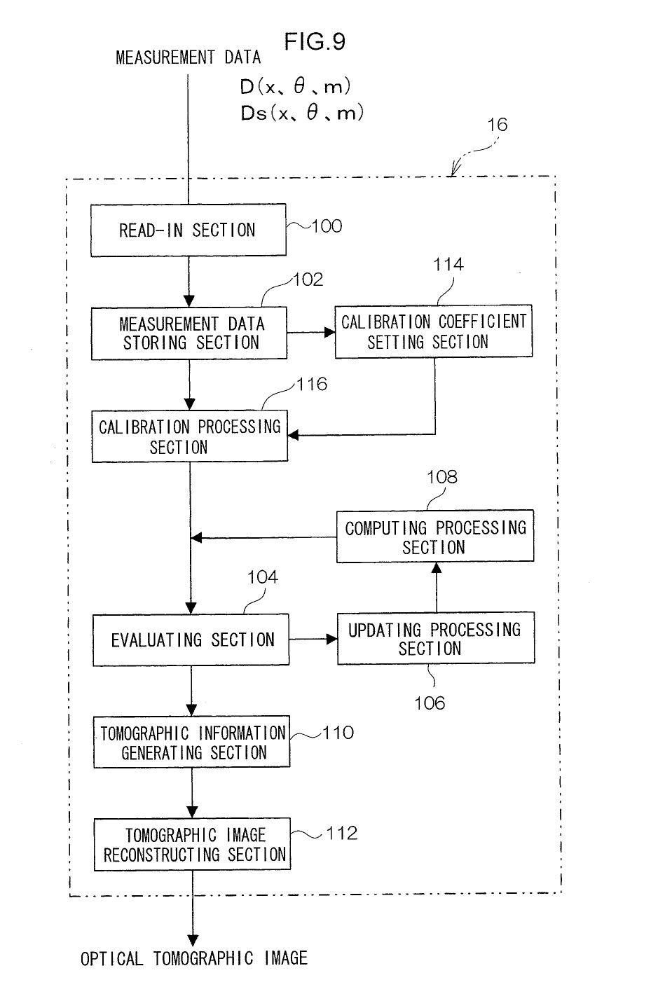

As shown in FIG. 9, a read-in section 100 and a measurement data storing section 102 are formed at the data processing device 16. At the data processing device 16, when the measurement data outputted from the optical measuring device 14 (the measurement data D(x,θ,m) and the measurement data Ds(x,θ,m) for calibration) are read-in at the read-in section 100, the measurement data are stored in the measurement data storing section 102, e.g., the HDD 78D or the like.

An evaluating section 104, an updating processing section 106, a computing processing section 108, a tomographic information generating section 110, and a tomographic image reconstructing section 124 are formed at the data processing device 16. At the computing processing section 108, the intensity of the fluorescence is computed by inverse problem computation that uses a light diffusion equation on the basis of optical characteristic values that are set in advance and that include the absorption coefficient, with respect to light, of the fluorescent labeling agent administered to the body of the mouse 12.

The evaluating section 104 evaluates the differences in the intensities of the fluorescence obtained from the computed intensity of the fluorescence and the measurement data D(x,θ,m). Note that the reconstructing of the optical tomographic image is carried out with respect to the one measurement surface 22A or with respect to the measurement surfaces 22A that are selected arbitrarily. For example, reconstruction is carried out by using the measurement data D(x,θ,m) obtained from plural movement positions x, or by using measurement data D(θ,m) for any movement position x.

At the updating processing section 106, by carrying out inverse problem computation of a light diffusion equation, the absorption coefficient, that is based on the density distribution of the phosphor, is set from the intensity of the fluorescence so that the differences obtained from the evaluation results of the evaluating section 104 are reduced. Moreover, at the computing processing section 108, when the absorption coefficient that is based on the density distribution of the fluorescent labeling agent is updated at the updating processing section 106, computation of the intensity of the fluorescence is carried out by using the updated absorption coefficient that is based on the density distribution of the fluorescent labeling agent.

Updating and evaluating of the intensity of the fluorescence are repeated this way, and when, for example, it is evaluated that the computed intensity of the fluorescence and the measurement data coincide, the tomographic information generating section 110 generates a density distribution (intensity distribution) of fluorescence that is optical tomographic information, from the absorption coefficient that is based on the density distribution of the fluorescent labeling agent at that time, and the tomographic image reconstructing section 112 reconstructs an optical tomographic image on the basis of this optical tomographic information. Note that, in reconstructing the optical tomographic image, an arbitrary structure can be applied provided that it is a structure in which the fluorescence intensity of the fluorescent labeling agent is measured, and, on the basis of the measurement data D(x,θ,m) or the measurement data D(θ,m) obtained therefrom, computation results that are based on a light transport equation or a light diffusion equation are used. Detailed description thereof is omitted here.

On the other hand, a calibration coefficient setting section 114 and a calibration processing section 116 are formed at the data processing device 16. At the calibration coefficient setting section 114, when the measurement data Ds(x,θ,m) for calibration, that is obtained by using the reference member 82 for calibration, is stored in the measurement data storing section 102, the calibration coefficients K(m) are set by using this measurement data Ds(x,θ,m) so that the respective light-receiving units 42 are considered to have equal sensitivities.

Here, in the setting of the calibration coefficients K(m) by the calibration coefficient setting section 114, for example, a calibration coefficient may be set for each of the light-receiving units 42 by averaging the θ₁ through θ₁₂ corresponding to the position x for each light-receiving unit 42 from the measurement data Ds(x,θ,m). Or, the calibration coefficients may be set by using a statistical method, on the basis of the measurement data Ds(x,θ,m) obtained at plural movement positions x by moving the reference member 82 for calibration in the axial direction.

At the calibration processing section 116, prior to reconstructing a tomographic image using the measurement data D(x,θ,m), calibration of the measurement data D(x,θ,m) is carried out by using the calibration coefficients K(m). For example, from the calibration coefficients K(m) whose parameters are the variables m that specify the light-receiving units 42, calibration measurement data Dc(x,θ,m) is acquired as Dc(x,θ,m)=D(x,θ,m)*K(m). This calibration measurement data Dc(x,θ,m) is outputted as measurement data (calibrated measurement data) D(x,θ,m). At the data processing device 16, reconstruction of the tomographic image is carried out on the basis of this calibrated measurement data D(x,θ,m) (=Dc(x,θ,m)).

Calibration of the light-receiving units 42 of the optical measuring device 14 in the optical tomographic measuring system 10 is described hereinafter as operation of the present exemplary embodiment.

At the optical measuring device 14, when calibration of the light-receiving units 42 is to be carried out, the reference member 82 for calibration is installed instead of the subject holder 30 that accommodates the mouse 12. At the optical measuring device 14, a predetermined position of the reference member 82 for calibration is moved so as to become the reference surface 22A of the measuring head portion 22. By illuminating light from the reference light source unit 84 onto the reference member 82 for calibration, the light exiting from the peripheral surface of the reference member 82 for calibration is measured at the light-receiving units 42A through 42K, respectively.

As methods for setting the calibration coefficients K(m) by using the measurement data Ds(x,θ,m), there are a method using measurement data Ds(x₀,θ,m) at a movement position x₀ and an angle (rotational position θ₁) that are set in advance, a method using measurement data Ds(x₀,θ,m) that is obtained by changing the angle (rotational position θ) to θ₁ through θ₁₂ or the like at the movement position x₀ that is set in advance, and a method using the measurement data Ds(x,θ,m) that is obtained by varying the movement position x and the rotational position θ. These methods are described as Example 1, Example 2, and Example 3.

### Example 1

At the optical tomographic measuring system 10, for example, a calibration setting mode is provided as an operation mode of the optical measuring device 14 and the data processing device 16. At the optical measuring device 14, due to operation in accordance with this calibration setting mode being instructed, the measurement data Ds(x,θ,m) is acquired by using the reference member 82 for calibration.

In Example 1, by operating the slider 56, the optical measuring device 14 disposes a predetermined position (e.g., movement position x₀ in FIG. 2) of the reference member 82 for calibration to become the measurement surface 22A. Further, the optical measuring device 14 places the frame 26 of the measuring head portion 22 at a rotational position (e.g., rotational position θ₁) that is set in advance. Namely, the optical measuring device 14 disposes the respective light-receiving units 42A through 42K at the movement position x₀ and the rotational position θ₁, that are set in advance, with respect to the reference member 82 for calibration.

Thereafter, the optical measuring device 14 operates the reference light source unit 84 such that light is illuminated toward the axial center from one end (the reference surface 82A) along the axial direction of the reference member 82 for calibration, and the lights that exit along the measurement surface 22A are received at the light-receiving units 42A through 42K, respectively. Due thereto, the measurement data Ds(x₀,θ,m) is acquired at the optical measuring device 14.

Here, the reference member 82 for calibration is formed by using an anisotropic scattering medium, so that the equivalent scattering coefficients are uniform. The light illuminated onto the axially central portion of the reference member 82 for calibration propagates while repeating isotropic scattering. The light, that propagates while isotropically scattering, attenuates in accordance with the propagated distance. However, if the distance over which the light propagates is the same, the light amounts also can be considered to be the same. Note that the light that is incident on the reference member 82 for calibration propagates by forward scattering until reaching the light penetration length. However, because this forward scatting region is approximately several mm, it can be considered that the light propagates while substantially scattering isotropically.

Here, as shown in FIG. 1, the reference member 82 for calibration is formed in the shape of a solid cylinder. Accordingly, the intensities of the lights that exit from positions intersecting the measurement surface 22A at the outer peripheral surface of the reference member 82 for calibration, are equal.

Further, by disposing the respective light-receiving units 42 on a circumference whose center is the axial center of the reference member 82 for calibration, the measurement data Ds(m) outputted from the respective light-receiving units 42 are equivalent. At the optical measuring device 14, the measurement data Ds(m) is outputted to the data processing device 16, and operation in the calibration setting mode ends.

At the data processing device 16, in the calibration setting mode, when the measurement data Ds(x,θ,m) (here, measurement data Ds(m)) is outputted from the optical measuring device 14, the data processing device 16 reads-in this measurement data Ds(m). Thereafter, at the calibration coefficient setting section 114, the data processing device 16 sets the calibration coefficient K(m) for each of the light-receiving units 42 on the basis of the measurement data Ds(m).

At the calibration coefficient setting section 114, the minimum value (measurement data Dmin) of the measurement data Ds(m), which minimum value (Dmin) is used as the reference, is selected, and the calibration coefficients K(m) of the respective light-receiving units 42 are set as the calibration coefficients K(m)=Dmin/Ds(m). The calibration coefficient K(m) is K(m)≦1.

Here, for example, if the measurement data Ds(2) obtained by the light-receiving unit 42 that is m=2 is the minimum value Dmin from the measurement data Ds(m) as shown in Table 1, the calibration coefficients K(m) of the respective light-receiving units 42 are set by using this measurement data as the reference.

TABLE 1

light-receiving unit m

| | 1 | 2 | . . . | 11 |
|---|---|---|---|---|
| measurement data D (m) | 3.120 | 2.970 | . . . | 3.300 |
| correction coefficient K (m) | 0.935 | 1.00 | . . . | 0.900 |

Due thereto, the calibration coefficient K(m) at the light-receiving unit 42 that is m=2 is K(2)=1, and the calibration coefficient K(1) at the light-receiving unit 42 that is m=1 is K(1)=0.935, and the calibration coefficient K(11) at the light-receiving unit 42 that is m=11 is K(11)=0.900. At the data processing device 16, the calibration coefficients K(m) that are set in this way are stored, and processing in the calibration setting mode ends.

By using the calibration coefficients K(m) that are set in this way, the measurement data D(x,θ,m), from which differences in the sensitivities of the light-receiving units 42A through 42K have been removed, is obtained. By carrying out reconstruction of the optical tomographic image on the basis of this measurement data D(x,θ,m), a highly accurate image is obtained.

Further, at the optical measuring device 14, light, that is of a wavelength equivalent to that of the fluorescence that is emitted by the fluorescent labeling agent administered to the mouse, is used as the light that the reference light source unit 84 emits. Therefore, the light that is used as a reference can be received accurately by the respective light-receiving units 42. Namely, if the wavelength that the reference light source unit 84 emits falls outside of the optical characteristics set at the light-receiving units 42, the light is attenuated at the light-receiving units 42, and therefore, the efficiency decreases. Further, if there are differences in optical characteristics among the light-receiving units 42A through 42K in a band that falls outside of the wavelength of fluorescence, even if equivalent light amounts are received, the data that is outputted differs, and proper calibration cannot be carried out. However, such problems can be prevented from arising.

Note that, here, the calibration coefficients K(m) are set by using the measurement data Dmin that is the minimum value as a reference. However, the present invention is not limited to the same, and an arbitrary structure can be applied such as using the average value or an averaged value of the measurement data Ds(m) as the reference value, or the like.

### Second Example

In a second example, in the optical measuring device 14, when operation in the calibration setting mode is instructed, a predetermined position of the reference member 82 for calibration (e.g., movement position x₀ in FIG. 2) is disposed at the reference surface 22A due to the slider 56 being operated.

Thereafter, at the optical measuring device 14, by operating the rotary actuator 28, measurement data of the respective light-receiving units 42 at the respective rotational positions θ are obtained while the rotational positions θ of the light-receiving units 42 are changed. Here, for example, the light-receiving units 42 are rotated 30° each, and measurement data Ds(θ,m) are obtained by the light emitted from the peripheral surface of the reference member 82 for calibration being received at the respective θ₁ through θ₁₂.

Namely, at the optical measuring device 14, when the reference member 82 for calibration is moved so as to be at the movement position x0 that is set in advance, the rotational positions θ of the light-receiving units 42 are changed in order from positions θ₁ to θ₁₂ by the rotary actuator 28, and, at each rotational position 8, the light exiting from the reference member 82 for calibration is measured by the light-receiving units 42. Due thereto, measurement data Ds(x₀,θ,m)=Ds(θ,m) is obtained at the optical measuring device 14.

At the data processing device 16, when the measurement data Ds (θ,m) is read-in, the calibration coefficients K(m) are set at the calibration coefficient setting section 114.

At this time, at the calibration coefficient setting section 114, for example, an average value Da(m) of the measurement data is computed for each of the light-receiving units 42 by using the measurement data Ds(θ) (where θ=θ₁ through θ₁₂) of each light-receiving unit 42 from the measurement data Ds (θ,m). Note that the measurement data Ds(m) of each light-receiving unit 42 is not limited to a value that averages the measurement data D(m), and a value that is normalized by an arbitrary statistical method may be used.

Thereafter, at the calibration coefficient setting section 114, the minimum value (measurement data Damin) of the average values Da(m) is set, and, by using this minimum value as a reference, the calibration coefficients K(m) of the respective light-receiving units 42 are set from calibration coefficients K(m)=Damin/Da(m). The calibration coefficients K(m) that are set at this time are K(m)>1.

By setting the calibration coefficients K(m) in this way, errors in the calibration coefficients K(m), that are caused by the cross-sectional shape of the reference member 82 for calibration at the measurement surface 22A, offset of the axial center, or the like can be suppressed. Namely, differences in the intensities of the lights exiting from the peripheral surface arise due to the cross-sectional shape of the reference member 82 for calibration or offset of the axial center with respect to the rotational center of the frame 26. Further, if the rotational center of the frame 26 and the axial center of the reference member 82 for calibration are offset, or the like, differences arise in the interval between the peripheral surface of the reference member 82 for calibration and each light-receiving unit 42, and due to these differences, the intensities of the lights received at the light-receiving units 42 differ as well.

In contrast, at the optical measuring device 14, each of the plural light-receiving units 42 measures light that exits from the same position of the reference member 82 for calibration. Due thereto, measurement data Ds(x₀,θ,m) of a time when lights of equivalent intensities are received, is obtained.

By setting the calibration coefficients K(m) by using this measurement data Ds(x₀,θ,m), the calibration coefficients K(m), in which errors due to the shape of the reference member 82 for calibration or the mounted positions of the respective light-receiving units 42 are suppressed, are obtained. Accordingly, the shape of the reference member 82 for calibration is not limited to cylindrical, and can be an arbitrary shape provided that the cross-sectional shape is uniform, such as a prism or the like.

By using the calibration coefficients K(m), measurement data D(x,θ,m) in which differences in the sensitivities of the light-receiving units 42A through 42K are removed, is obtained. By reconstructing an optical tomographic image on the basis of this measurement data D(x,θ,m), a highly accurate image is obtained.

### Third Example

In the third example, measurement data (measurement data Ds(x,θ,m)), in which, in addition to the rotational positions θ of the light-receiving units 42, the distance (movement position x) of the measurement surface 22A with respect to the light illuminating position of the reference light source unit 84 is changed, is acquired.

In the optical measuring device 14, when operation in the calibration setting mode is instructed, the slider 56 is operated and moves the reference member 82 for calibration to a movement position that is set in advance (hereinafter “movement position x₀”). Thereafter, at the optical measuring device 14, measurement of light emitted from the reference light source unit 84 is carried out while repeating rotation of the measuring head portion 22 (the light-receiving units 42) and movement of the reference member 82 for calibration.

Here, the intensity (light amount) of the light illuminated from the reference light source unit 84 varies in accordance with the distance that the light propagates within the reference member 82 for calibration. From this, in the optical measuring device 14, the distance between the reference light source unit 84 and the measurement surface 22A or the light-receiving units 42 is varied by moving the reference member 82 for calibration to a range at which the light amount of the light received at the light-receiving units 42 decreases to a predetermined value.

Here, in the optical measuring device 14, the reference member 82 for calibration is moved in a range in which the light amounts (the outputs of the light-receiving units 42) decrease to 1/10⁻⁴ from the movement position x₀. If the movement amount at this time is 10 mm, the movement amount Δx in this movement range is made to be Δx=1 mm, and the reference member 82 for calibration and the reference light source unit 84 are moved (e.g., positions x₀, x₁, . . . , x₉), and measurement is carried out 10 times. Further, at each of the movement positions x, measurement is carried out twelve times by rotating the light-receiving units 42 successively from rotational positions θ₁ through θ₁₂. Due thereto, measurement data Ds(x,θ,m) (where m=1 through 11, x=x₀ through x₉, θ=θ₁ through θ₁₂) is obtained. At the data processing device 16, setting of the calibration coefficients K(m) is carried out on the basis of this measurement data D(x,θ,m).

The measurement data Ds(x,θ,m) includes measurement data Ds(m) (Ds(m)=Ds(x,θ)) for each light-receiving unit 42. Due thereto, for the light-receiving unit 42 that is specified by m=1 for example, measurement data Ds(1)=Ds(x,θ) as shown in Table 2 is obtained.

TABLE 2

| | rotational position θ | | | | |
|---|---|---|---|---|---|
| position x | | | . . . | | average |
| x₀ | 3.210 | 3. . . . | . . . | 3. . . . | 3. . . . |
| x₁ | . . . | . . . | . . . | . . . | . . . |
| . . . | . . . | . . . | . . . | . . . | . . . |
| x₉ | . . . | . . . | . . . | . . . | . . . |

Here, at the calibration coefficient setting section 114, the average value Da(m) of the measurement data at each movement position x (x₀, x₁, . . . , x₉) is computed for each light-receiving unit 42. Due thereto, an average value Da(m) of measurement data at each movement position x is obtained for each of the light-receiving units 42 (refer to the Second Example). By normalizing the average values Da(m) such that the maximum value becomes 1, data such as shown in Table 3 is obtained.

TABLE 3

light-receiving unit m

| position x | 1 | 2 | . . . | 11 |
|---|---|---|---|---|
| x₀ | 1.0000 | 0.9000 | . . . | 0. . . . |
| x₁ | 0. . . . | 0. . . . | . . . | 0. . . . |
| . . . | . . . | . . . | . . . | . . . |
| x₉ | 0. . . . | 0. . . . | . . . | 0. . . . |

For example, at the light-receiving unit 42 that is specified by m=1, if the average value Da(x,m)=Da(x₀,1) of the movement position x0 is the maximum value, the standardized data Ds(m) becomes Ds(m)=Da(x,m)/Da(x₀,1). At this time, for example, at the light-receiving unit 42 that is specified by m=1, Ds(1)=1.000, and, at the light-receiving unit 42 that is specified by m=2, Ds(2)=0.900.

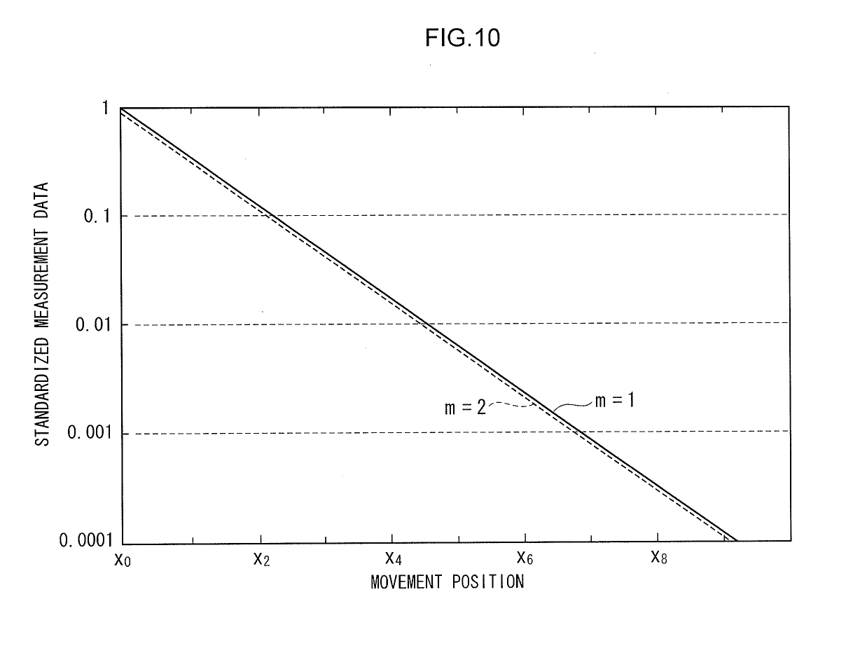

FIG. 10 is a graph in which data that are obtained in this way are plotted. This graph is a semi-logarithmic graph in which the vertical axis (Y-axis) is the logarithmic axis, and the movement position x along the axial direction with respect to the reference member 82 for calibration, that is the distance, is on the horizontal axis. Note that, in this graph, the light-receiving units 42 specified by m=1, m=2 are examples.

As shown in FIG. 10, it is preferable that the standardized data is a regression straight line (a straight line of a slope of −1) in which the measurement data Da(m) decreases at a constant slope in accordance with the distance.

Here, there are cases in which the standardized data in Table 3 includes dispersion. For example, in Table 3, Ds(1)=1.000, Ds(2)=0.900 are Y intercepts on the graph of FIG. 10. In Table 3, the logarithmic values z(m) of this Y segment are z(1)=log(Da(x₀,m)=0.0, z(2)=log(Da(X₀,m)=−0.0458.

In contrast, from the data shown in Table 3, for each of m=1 through 11, a regression straight line is determined by using the position x on the x-axis as an explanatory variable and by using the measured value of each light-receiving unit 42 that is on the y-axis as the target variable. At this time, the logarithmic value L(m) (L(m)=Ds(x₀,m)) of the Y segment on each regression straight line is the data shown in Table 4.

TABLE 4

light-receiving unit m

| position x | 1 | 2 | . . . | 11 |
|---|---|---|---|---|
| L (m) | −0.0025 | −0.0486 | . . . | −0. . . . |
| Ds (m) | 0.9942 | 0.8942 | . . . | 0.9 . . . |
| K (m) | 0.8994 | 1.000 | . . . | 0.9 . . . |

Here, a standardized value C(m) (C(m)=10^{L(m)}), that is the 10 to the power of the logarithmic value L(m), is determined. At this time, for example, the standardized value C(1) for m=1 is C(1)=0.9942, and the standardized value C(2) for m=2 is C(2)=0.8942. This standardized value C(m) is a value in which the dispersion has been removed from the normalized data Ds(m) shown in Table 3. The calibration coefficients K(m) are determined (K(m)=Cmin/C(m))) by using, as a reference, a minimum value Cmin that is selected from the standardized values C(m).

By using the calibration coefficients K(m) that are obtained on the basis of a regression straight line method that is one such statistical method, the calibration coefficients K(m) that have a wider dynamic range are obtained. Even if differences arise in the light amounts received at the light-receiving units 42, the measurement data D(x,θ,m) that has been calibrated correctly can be obtained.

Note that the above-described exemplary embodiment does not limit the structure of the present invention. For example, in the present exemplary embodiment, the measurement data is calibrated at the data processing device 16. However, the present invention is not limited to the same, and calibration of the measurement data may be carried out at the optical measuring device 14, and the calibrated measurement data may be outputted to the data processing device 16.

Further, at the optical measuring device 14, sensitivity calibration of the plural light-receiving units 42 can be carried out appropriately by using the reference member 82 for calibration and the reference light source unit 84. At this time, the calibration coefficients K(m) are set on the basis of the measurement data Ds(x,θ,m) obtained from the reference member 82 for calibration, and, by using the set calibration coefficients K(m), calibration with respect to the respective measurement data of the light-receiving units 42 is carried out. Due thereto, in the optical tomographic measuring system 10, a deterioration in image quality caused by dispersion in the sensitivities of the light-receiving units 42 is reliably prevented, and reconstruction of a highly-accurate optical tomographic image is possible.

Further, at the optical measuring device 14, sensitivity calibration of the light-receiving units 42 can be carried out simply in a state in which the plural light-receiving units 42 are mounted to the frame 26.

Note that the present exemplary embodiment describes the optical measuring device 14 as an example, but the present invention is not limited to the same. For example, the present invention can be applied to the calibration of sensitivities of plural light-receiving units that are mounted on the same circumference with their optical axes being directed toward the axial center. In this case, the reference member 82 for calibration is mounted at the axially central portion, and light from the reference light source unit 84 is illuminated from one axial direction end side of the reference member 82 for calibration. Due thereto, the light amounts of the lights that the plural light-receiving units respectively detect can be made to be uniform, and therefore, sensitivity calibration can be carried out by using these results of measurement.

Further, the present exemplary embodiment uses, as the reference sample, the reference member 82 for calibration that is formed in the shape of a solid cylinder. However, the reference sample is not limited to the same, and can have an arbitrary external shape provided that it is a columnar member having a shape in which the cross-section is uniform, such as a cross-sectional shape that is a regular dodecagon or the like.

Moreover, although the mouse 12 is described as an example of the measurement sample in the present exemplary embodiment, the present invention can be applied to optical measuring devices of arbitrary structures that measure, by plural light-receiving units, lights that exit from an object of measurement, and to calibration devices for such optical measuring devices.

What is claimed is:

1. An optical measuring device comprising:
a plurality of light-receiving units that each receive light of a predetermined wavelength via a light-receiving element;
a frame to which the respective light-receiving units are mounted on a same circumference whose axial center is a predetermined position, with optical axes of the light-receiving units being directed toward the axial center, an object of measurement being disposed at an axially central portion of the circumference;
a measuring section that, at the respective light-receiving elements of the plurality of light-receiving units, receives light exiting from the object of measurement that is disposed at the axially central portion of the circumference, and that outputs measured values corresponding to received light amounts;
a reference sample that is formed in a shape of a pillar having a predetermined cross-sectional shape and that is formed of a material at which isotropic scattering of light occurs as an optical characteristic, wherein in a case of carrying out calibration of sensitivities of the plurality of light-receiving units, the reference sample is disposed, instead of the object of measurement, at the axially central portion of the circumference such that a longitudinal direction of the reference sample runs along an axis of the circumference;
a reference light source that is disposed on the axis of the circumference so as to face one surface in the longitudinal direction of the reference sample that is disposed at the axially central portion of the circumference, and that illuminates light of the predetermined wavelength toward the reference sample; and
a calibrating section that calibrates the sensitivities of the plurality of light-receiving units at a time of measuring the object of measurement, on the basis of measured values for calibration that are outputted from the measuring section due to light, that exits from an outer peripheral surface of the reference sample in accordance with light illuminated from the reference light source onto the reference sample, being received at the respective light-receiving units.

2. The optical measuring device of claim 1, further comprising a moving section that relatively moves the object of measurement and the frame, at which the light-receiving units are provided, along the axis of the circumference,
wherein the measuring section relatively moves the reference sample and the light-receiving units along the axial direction by the moving section, and outputs the measured values for calibration at a plurality of movement positions.

3. The optical measuring device of claim 1, further comprising a rotating section that relatively rotates the frame, at which the light-receiving units are provided, with respect to the object of measurement in a direction of the circumference,
wherein the measuring section relatively rotates the light-receiving units with respect to the reference sample in the circumferential direction by the rotating section, and outputs the measured values for calibration at a plurality of rotational positions.

4. The optical measuring device of claim 1, wherein the calibrating section includes a calibration setting section that, from the measured values for calibration that the measuring section outputs, sets a calibration coefficient for each of the light-receiving units such that the measured values for calibration of the respective light-receiving units coincide.

5. The optical measuring device of claim 4, further comprising a calibration processing section that, on the basis of the calibration coefficients set at the calibration setting section, carries out calibration of the measured values of the respective light-receiving units that are outputted from the measuring section.

6. The optical measuring device of claim 1, further comprising a light source that is provided at the frame and that illuminates, toward the axially central portion, excitation light with respect to a fluorescent labeling agent that is contained in the object of measurement,
wherein the measuring section measures, at each of the plurality of light-receiving units, fluorescence that is emitted from the fluorescent labeling agent of the object of measurement in accordance with the excitation light illuminated from the light source.

7. A calibration device that calibrates a plurality of light-receiving units that are mounted to a frame on a same circumference whose axial center is a predetermined position, with optical axes of the light-receiving units being directed toward the axial center of the circumference, and that each receive light of a predetermined wavelength by a light-receiving element and output a measured value corresponding to a received light amount, the calibration device comprising:
a reference sample that is formed in a shape of a pillar having a predetermined cross-sectional shape and of a material at which isotropic scattering of light occurs as an optical characteristic, and that is disposed at an axially central portion of the circumference such that a longitudinal direction of the reference sample runs along an axis of the circumference;
a reference light source that is disposed on the axis of the circumference so as to face one surface in the longitudinal direction of the reference sample, and that illuminates light of the predetermined wavelength toward the reference sample;
a measuring section that, at the respective light-receiving units, receives light exiting from an outer peripheral surface of the reference sample in accordance with light illuminated from the reference light source onto the reference sample, and that outputs measured values for calibration corresponding to received light amounts; and
a calibrating section that calibrates sensitivities of the plurality of light-receiving units on the basis of the measured values for calibration that are outputted from the measuring section.

8. The calibration device of claim 7, further comprising a moving section that relatively moves the reference sample and the frame, at which the light-receiving units are provided, along the axis of the circumference,
wherein the measuring section relatively moves the reference sample and the light-receiving units along the axis by the moving section, and outputs the measured values for calibration at a plurality of movement positions.

9. The calibration device of claim 7, further comprising a rotating section that relatively rotates, in a direction of the circumference, the object of measurement with respect to the frame at which the light-receiving units are provided,
wherein the measuring section relatively rotates the light-receiving units with respect to the reference sample by the rotating section, and outputs the measured values for calibration at a plurality of rotational positions.

10. The calibration device of claim 7, wherein the calibrating section includes a calibration setting section that, from the measured values for calibration that the measuring section outputs, sets a calibration coefficient for each of the light-receiving units such that the measured values for calibration of the respective light-receiving units coincide.
